(19) United States
(12) Patent Application Publication
(10) Pub. No.: US 2019/0001337 A1
(43) Pub. Date: Jan. 3, 2019

(54) Modular Pulverizer

(71) Applicant: Jaroslaw Lutoslawski, Bradford (CA)

(72) Inventor: Jaroslaw Lutoslawski, Bradford (CA)

(21) Appl. No.: 15/405,414

(22) Filed: Jan. 13, 2017

Related U.S. Application Data
(60) Provisional application No. 62/278,089, filed on Jan. 13, 2016.

(51) Int. Cl. B02C 13/288; B02C 13/14

(52) U.S. Cl. CPC B02C 13/288; B02C 2201/06; B02C 13/14

(57) ABSTRACT

A drum for a pulverizer is preferably modularly constructed, preferably from planar panels thereby significantly reducing manufacturing costs. Additionally, some embodiments may utilize a drum liner in drum liner portions to assist in protecting drums, whether they be modularly or traditionally constructed.

### CLAIM OF PRIORITY

This application claims the benefit of U.S. Provisional Patent Application No. 62/278,089 filed Jan. 13, 2016, which is incorporated herein by reference in its entirety.

### FIELD OF THE INVENTION

The present invention relates to a pulverizer also known as a vertical grinding mill which are normally provided with a rotating shaft with a plurality of arms spinning thereabout which generate a series of air currents inside of a cylinder to pulverize, aerate, homogenize and/or separate material.

### BACKGROUND OF THE INVENTION

Solid materials such as garbage, rubbish or other solid materials have been collected by trucks and transported for disposal for many years.

Burkett developed a centrifugal mill sometime around in the mid-1970s and ended up with U.S. Pat. No. 3,987,970 and others. The applicant's predecessor-in-interest filed Canadian Patent Application Nos. 2,125,797 and 2,147,666 for use with various equipment and methods for pulverizing rock and remediating soil utilizing an improved pulverizer configuration. These three patents and patent applications are incorporated herein by reference in their entirety.

Still others have commercialized an embodiment of the Burkett mill and are trying to sell that design in the marketplace today. However, when attempting to build a Burkett mill with improvements, the applicant discovered there were components of that basic design which could be improved.

### SUMMARY OF THE INVENTION

It is a present object of many embodiments of the present invention to provide an improved vertical gyroscopic mill or pulverizer having advanced capabilities.

It is another object of many embodiments of the present invention to provide a modular construction for a pulverizer mount so that the pulverizer can be made to be relatively simple in construction and fabrication characteristics to potentially reduce costs of the unit as well as to simplify the building and/or maintenance processes.

It is another object of the present invention to provide an ability to replace certain parts of a pulverizer drum without having to replace all the parts should some part fail or wear excessively.

Accordingly, in accordance with the presently preferred embodiment of the present invention, a modular pulverizer is provided. Specifically, instead of the housing being a rolled piece of metal of a sufficient thickness to withstand impacts from extremely rapidly rotating materials thrown around the body of the pulverizer, the body is instead divided into a series of modular segments or panels, and for many embodiments those panels can be interchangeable. Additionally, the panels can have lips which cooperate with lips of adjacent panels to provide a location for connecting adjacent panels together. Additionally, these lips can provide many secondary functions that may or may not be critical to the process.

Additionally, a series of drum liner attachments can be attached internally to the panels and/or housings of other embodiments so that should any of the drum liner panels be compromised or worn out, a single panel and/or individual panels could be swapped out with others without a need to replace the entire housing. These easily accessible liners can also be retained by the shelves or other internal components.

Additionally, a discharge from the pulverizer can be made as a single component so that panels can possibly be substantially identical above the discharge. In fact, one panel may hingedly connect to another for some embodiments so that the panel provides internal access.

### BRIEF DESCRIPTION OF THE DRAWINGS

The particular features and advantages of the invention as well as other objects will become apparent from the following description taken in connection with the accompanying drawings in which:

FIG. 1 is a pulverizer construction of the presently preferred embodiment of the present invention;

FIG. 2 is an exploded construction view showing the components of a pulverizer shown in FIG. 1; and

FIG. 3 is a cross-sectional view of a pulverizer drum with drum liner attachments as used with a presently preferred embodiment of the invention as shown in FIGS. 1 and 2.

### DETAILED DESCRIPTION OF THE PREFERRED EMBODIMENTS

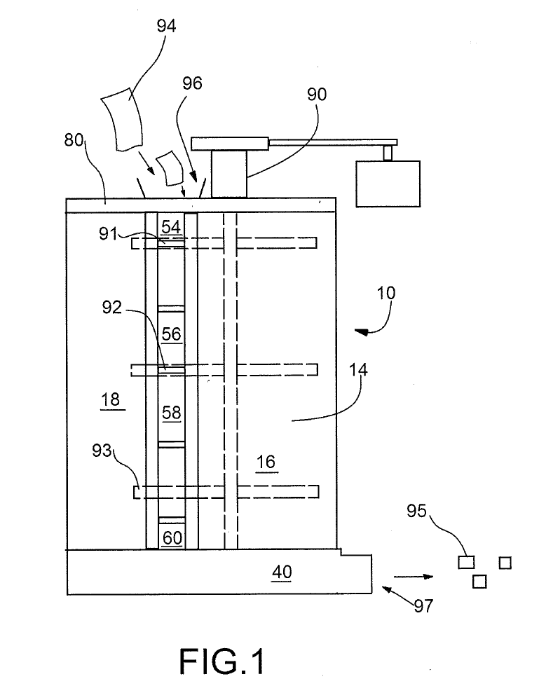

FIG. 1 shows a pulverizer 10 of a presently preferred embodiment of the present invention. The pulverizer may be constructed with a modular drum configuration. Specifically, a series of panels 12,14,16,18,20,22, many if not all of which, may be similarly constructed may be connected together with adjacent lips 24,26 to form a drum 11. Specifically, the first lip 24 may connect to a second lip 26 of an adjacent panel 22 either internally or externally relative to the inside of the drum 11. The panels 12-22 may have bores such as a series of bores 28,30 etc. to allow for a connection to be made. Bolts may connect many adjacent panels 12-22 or the lips 24,26 may be otherwise connected for many adjacent panels 12-22 such as by welding, etc. The bores 28,30 may also be used for other features as will be described in further detail below, and additionally, there may be external connectors which may connect at shoulders 32,34 to assist in connecting adjacent panels such as 16,18 as well as feet 36,38 which may also connect together, possibly to a bottom portion 40. The feet 36,38 can connect to discharge piece or bottom portion 40 such as at perimeter bores 42,44. Furthermore, perimeter bores 46,48 of bottom portion 40 may be useful to connect to perimeter bores 50,52 of the panels 12-22. A top can be similarly or dissimilarly connected.

In one presently preferred embodiment of the present invention, the panels 12-22 can be made similarly or even identically and so that the six panels 12-22 can come together to form a circumference about the perimeter 50 of the bottom portion 40. This way, the panels 12-22 need not be rolled after forming to a precise circumference. Instead, each of the panels 12-22 may have a first and second portion 52-54 which may angularly meet together such as at about 30 degrees so that the six panels 12-22 can come together to form a complete circumference about the perimeter 50 of the bottom portion 40 so that no material escapes between the adjacent panels 12-22 during operation by connecting lips such as lips 24,26 to one another or alternatively either in a permanent manner such as by welding or using connectors such as through bores 28-30 and/or other connection. It may also be alternatively possible that at least one of the panels 12-22 is allowed to be a door relative to the other panels and may selectively lock in position during use in a locked configuration and then be able to be hingedly connected to an adjacent panel such as having panel 16 be hingedly connected to panel 14 while having the capability of locking the panel 18 during operation while also allowing the panel 16 to rotate open to an open configuration during periods of non-use as one of ordinary skill in the art would understand to perform service internal to the drum 11.

Lips 24,26 are shown extending perpendicular to panel portions 52,54 and/or along radius of the drum (if thought of as round) and/or housing 61 to facilitate connection and/or construction.

Generally a consistent circumference about a large diameter cylindrical housing has been found to be expensive particularly when utilizing AR 400 or other metal. Few machine shops have been found to be willing to roll unitary drums to the desired shape. By providing the panel construction, the cost to form the housing or drum would significantly decrease.

Furthermore, by providing six separate panels 12-22 to provide a drum 11, possibly modular in nature, if any one of the panels 12-22 is harmed, they could simply be replaced without having to replace the entire housing. Furthermore, shipment of panels 12-22 as opposed to a unitary drum is extremely easier as well. The amount of steel can be decreased and assembly is believed to be greatly improved in efficiency other options. While six panels 12-22 are shown each having two portions, such as planar portions 52,53. Other embodiments may have other numbers of panels 12-22, possibly with other numbers of portions 52-53 and/or meeting at other angles. Furthermore, not all panels 16-22 need necessarily be similarly constructed for all embodiments.

While AR 400 or other high strength metal can be utilized, the various improvements disclosed herein can provide a design providing more panels than the six panels 12-22 illustrated and still other improvements.

Additionally, while making a modular drum construction, it is further anticipated that drum liner attachments could be modular in nature for at least some embodiments.

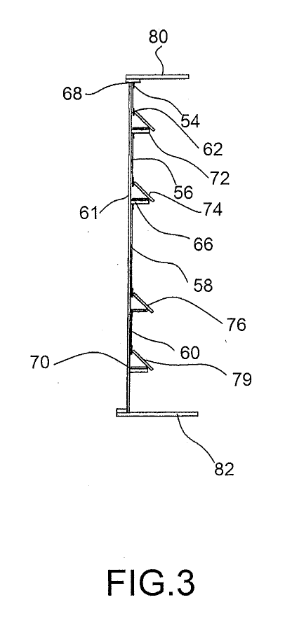

FIG. 3 shows first, second, third 54,56,58,60 drum liner attachments forming a drum liner 59 which can be located against drum 11 or housing wall 61 which could be along any of the panels 12-22 shown in FIG. 10 or any other pulverizer as is known in the art. Housing wall 61 may be curved (such as cylindrical) or angled (planar panel portions meeting) as described above or otherwise along insides of the drum 11. Specifically, the liners such as liners 54-60 can have seams 62,66,67 as well as 68,70 which may be protected from contact such as by shelves 72,74,76 as well as guard 76,78,79 at the top 80 and bottom 82 respectively.

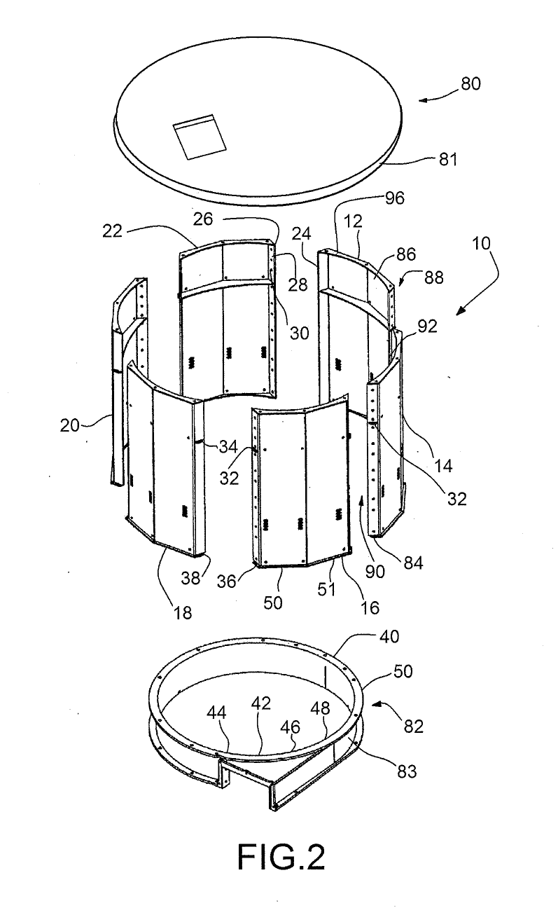

By lining a drum liner 59 in the form of portions such as portions 54,56,58,60 it may be possible to test different materials other than just AR400 rolled steel as has traditionally been utilized as a drum housing wall 61 in the past. It may be that there is a low cost wear product whether a fiberglass, an HDPE high density polyethylene, a ceramic, some steels, chromium carbide overlays, ceramic overlays and/or other materials that may benefit from being utilized as any of the drum liner attachment portions 54-60 as would be understood by the reference to FIG. 3 and FIG. 2 if three portions 54,56,58,60 were utilized on all six panels 12-22 then a total of four portions 54,56,58,60 were utilized per panel, then a total of twenty-four total portions 54,56,58,60 (four times six) could then be utilized. Of course, the drum 11 could be less wear resistant than prior art designs (or not) and the liner(s) 59 could address impact internal to the drum 11 and/or address other concerns. Internal surfaces 55 of the drum liner 59 could be curved, like a cylinder or otherwise, or be planar regardless of the curvature or planar nature of the housing wall 61 depending upon the design objectives of the pulverizer 10.

Of course, other constructions could provide fewer or more portions 54-60. Utilizing the shelves 62,66,67,72,74,76 it has been found that they provide a particularly efficient way to cover over the seams of adjacent portions as described above while other methods could connect in different ways. Additionally, the deflectors and/or shelves themselves may also be made in modular sets such as could be connected to each of the respective panels 12-22 such as in the form of portions 54-60 illustrated in FIG. 3 possibly only extending the width 84 of a single panel such as 18. Other portions 54-60 for other embodiments may be made to extend circumferentially about the entire drum. Other portions may extend vertically from top 80 to bottom 82 or anywhere in between.

Deflectors and/or shelves as shown in FIG. 1 may also be provided in modular form for at least some embodiments. The first and second planar portions 52,53 may be representative for each of the panels 12-22 or it may be that additional or fewer portions 52,53 would be provided for a respective panels such as 12 illustrated. Portions 52,54 may be planar and connect with an interface such as at interface 86 such as by a consistent angle from a top 88 to a bottom 90 of the panel 12. Other embodiments could be constructed differently.

Furthermore, intermediate lateral brace 92 could for structural support and can be in addition to a bottom base 94 as well as an upper extension 96 for structural integrity of each of the panels 12-22. Bases 92,94 and upper extension are shown extending from lip to lip 24,26 of each panel, for at least some embodiments.

By constructing panels 12-22 and/or drum liner attachment portions 54-60 in such a way the scalability modulator and costs can be significantly scalability can be increased, modularity can be made more efficient and the cost can be dropped to provide easier assembly for at least some embodiments in the presently preferred embodiment of the present invention.

Accordingly, a pulverizer 10 may comprise a top 80 having a perimeter 81, a bottom 82 having a perimeter 83, and a plurality of planar panel portions 52,53 connected together between the top 80 to the bottom 82 to provide a modular drum 11 construction. The pulverizer 10 also has a rotating shaft 90 having radially extending arms 91,92,93 (or other numbers, at possibly the same or other elevations as better described by the patents/patent applications incorporated by reference herein) creating flow currents within the pulverizer 10 thereby reducing the size of product input 94 near the top and discharged at the bottom as output 95. Unlike prior art constructions, the panel portions 52,53 can be planar, and preferably modular, rather than being formed of a single cylindrically rolled drum, which can be rather expensive to produce.

The pulverizer 10 can connect the top 80 to the plurality of panel portions 52,53 as well the bottom 82. The top 80 can have an inlet 96 while the bottom has an outlet 97 whereby material to be pulverized is fed in the inlet 96 as input 94, broken into smaller pieces, and then discharged from the outlet 97 as output 95.

Panels 12,14,16,18,20,22 and/or others can have multiple panel portions 52,53, such as first and second panel portions 52,53. Some, many or even all of the panels 12-22 may be similarly constructed. The panels 12-22 can have feet 36,38 which connect to the bottom 82, such as with respective bores 50,51 etc. and 46,48, etc. in each receiving connectors therethrough, or otherwise. The panels 12-22 can have lips 24,26 whereby adjacent lips 24,26 may connect with one another to assist in forming the drum 11. The lips 24,26 may also have shoulders 32 which can provide connection locations on an external surface of the drum 11.

For some embodiments, at least one panel portion 52,53, if not a panel 12-22, forms the door as shown in FIG. 1 or otherwise by being hingedly connected to another panel portion 52 or 53 (if not another panel 12-22) and having a locked shut configuration and an open configuration as described above, or otherwise.

Internal to the drum 11 can be at least one drum liner 59, if not a plurality of drum liner portions 54-60. The drum liner 59 can meet the top 80 and bottom 82 at seams 68,70, and drum liner portions 54-60 can meet one another at seams 62,66,67. The seams 62,66,67,68,70 can be covered with at least one of shelves 72,74,76 and/or guards 78,79. Shelves 72,74,76 can assist in directing flow in the pulverizer 10.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A pulverizer comprising:
a top having a perimeter;
a bottom having a perimeter;
a plurality of planar panel portions connected together between the top to the bottom to provide a modular drum construction;
a rotating shaft having radially extending arms creating flow currents within the pulverizer thereby reducing the size of product input near the top and discharged at the bottom.

2. The pulverizer of claim 1 wherein the top is connected to the plurality of panel portions.

3. The pulverizer of claim 2 wherein the bottom is connected to the plurality of panel portions.

4. The pulverizer of claim 1 wherein the bottom is connected to the plurality of panel portions

5. The pulverizer of claim 1 wherein the top has an inlet and the bottom has an outlet.

6. The pulverizer of claim 1 wherein a plurality of panels have first and second panel portions of the plurality of panel portions.

7. The pulverizer of claim 6 wherein at least some of the plurality of panels are similarly constructed.

8. The pulverizer of claim panels have feet, feet connect to the bottom.

9. The pulverizer of claim bores in the feet connect to bores in the bottom

10. The pulverizer of claim 7 panels have lips at edges and adjacent lips connect together internal to the drum to assist in forming drum

11. The pulverizer of claim 10 lips have shoulders on an external portion and shoulders connect external to the drum

12. The pulverizer of claim 1 wherein at least one panel portion forms a door hingedly connected to another panel portion whereby the door has a locked shut configuration and an open configuration permitting access through the door into the drum.

13. The pulverizer of claim 12 panel forms door

14. The pulverizer of claim drum liners internal to the drum

15. The pulverizer of claim plurality of drum liner portions

16. The pulverizer of claim drum liner portions meet at seams between top and bottom, at least some seems having shelf spanning the seam, said shelf at least assisting in directly flow through the pulverizer

17. The pulverizer of claim drum liner meets top at seam, guard protects seam

18. The pulverizer of claim drum liner meets bottom at seam, guard protects seam

19. A pulverizer comprising:
a top having a perimeter;
a bottom having a perimeter;
a drum located between the top to the bottom;
a liner internal to the drum;
a rotating shaft having radially extending arms creating flow currents within the pulverizer thereby reducing the size of product input near the top and discharged at the bottom;
said liner protecting the drum from product.

20. The pulverizer of claim 19 wherein the liner drum is comprised of planar panel portions extending intermediate the top and the bottom.
